(19) United States
(12) Patent Application Publication
(10) Pub. No.: US 2026/0194183 A1
(43) Pub. Date: Jul. 9, 2026

(54) Compressive force accommodating headgear and method

(71) Applicant: Roger J. Malcolm, San Clemente, CA (US)

(72) Inventor: Roger J. Malcolm, San Clemente, CA (US)

(21) Appl. No.: 19/130,956

(22) PCT Filed: Nov. 20, 2023
(86) PCT No.: PCT/US2023/080601

§ 371 Date: May 19, 2025

Related U.S. Application Data
(60) Provisional application No. 63/426,776, filed on Nov. 20, 2022.

(51) Int. Cl. F16M 13/04

(52) U.S. Cl. CPC F16M 13/04

(57) ABSTRACT

A body-worn device (40) for accommodating compressive forces on the head of a wearer. The device can include a rigid brace (42) spanning the head (10) in a substantially hat brim orientation. The brace can include a pair of extension arms (44a, 44b) extending laterally and posteriorly away from the temples. A posterior tensioning member (51,52) places the free ends (45b, 46b) of the arms under a laterally medial compressive force resisted by the rigidity of the brace, avoiding compression on the temple region of the head, thereby increasing comfort.

### PRIOR APPLICATION

This application claims the benefit of U.S. Provisional Patent Application Ser. No. 63/426,776, filed 20 Nov. 2022, incorporated herein by reference.

### FIELD OF THE INVENTION

This invention relates to body worn supports, and more particularly to load bearing headgear.

### BACKGROUND

Many types of headgear have been developed to accommodate forces placed on the head. For example, for centuries helmets have been used to protect the wearer's head from injuries due to impacts of foreign bodies, large and small.

Referring now to the drawing there is shown in FIG. 1 that a human head 16 can be substantailly bisected by three mutually orthogonal planes. A sagittal plane SP bisects the head vertically into left and right lateral halves. A coronal plane CP substantially bisects the head vertically into front and back portions. A transverse plane TP substantially bisects the head horizontally into top and bottom portions. The word substantially is used because the head is not symmetric about the coronal or transverse planes. In this specification the sagittal, coronal and transverse planes intersect the centroid or volumetric center of the head. These planes will help define the function of headgear.

FIGS. 2-3 show that a typical prior art headgear 20 can be mounted to the head 10 of a user. The headgear can include a flexible or semi-rigid headband 22 surrounding the head substantially within the transverse plane TP along with a flexible or semi-rigid vertical retaining band 23 extending across the top of the head substantially within or parallel to the coronal plane CP. The headgear can typically use flexible headbands to allow fine adjustment to the user's head to enhance fit and comfort. The headgear can be used to support an attachment 21 such as a headlamp projecting anteriorly from a frontal part of the headgear. Such an attachment can be supported in a cantilevered manner so that the weight W of the attachment under the influence of gravity creates a moment of force on the point of attachment to the headband. This moment of force is often strong enough to cause a downward pitch deflection of the attachment from the original position 24 of the attachment. A rigid interface structure 25 between the attachment and the headband can therefore be driven to pitch downwardly against the inferior point of contact 26 with the forehead causing discomfort.

As shown primarily in FIG. 3, the downward pitch deflection of the attachment 21 will tend to cause the top edge 27 of the headband 22 to peel anteriorly 28 away from the head 10 of the user often forming a gap 29 between the head and the top edge. The greater tension on the top edge of the headband can cause an uncomfortable pinching inwardly 19a,19b of the headband against the temples. During stress-related headaches, constant pressure on the temple can often lead to greater discomfort.

U.S. patent application Ser. No. 17/737,881 Malcolm et al. describes headgear for connecting the head to a body-worn device designed to support the head and neck from undue fatigue during repetitive, long duration activities such as the work of assembly line workers.

The device uses an adjustable cable to connect the headgear to a variable stiffness semi-rigid supporting member secured to the back of the user. The tension on the cable can cause the headband to deflect inwardly creating uncomfortable pressure points against the skull.

Composite materials such as carbon fiber reinforced polymers have long been used to create structural elements due to their low weight and high stiffness/strength to bending moments along the oblong fibers'orientation. U.S. Pat. No. 10,315,745 Malcolm describes orienting layers of fibers to adjust the longitudinal and rotational stiffness in different zones of a composite member.

Therefore, there is a need for an apparatus which addresses one or more of the above identified inadequacies.

### SUMMARY

The principal and secondary objects of the invention are to provide an improved compressive force accommodating headgear device. These and other objects can be achieved by a rigid arcuate frontal brace including cantilevered support arms that resist laterally compressive forces.

In some embodiments there is provided the combination of a headgear, and a substantially static support connected to the headgear by a straddling cable.

In some embodiments there is provided a device to be worn on a user's head, said device comprises: a rigid arcuate brace configured to span a wearer's head; wherein said brace comprises: a brow portion secured anteriorly to a frontal part of said user's head; a pair of arms cantileveredly connected to opposite lateral extents of said brow portion; wherein each of said support arms comprises: a free end laterally spaced a distance apart from said head; a first flexible tensioning member comprising: a first end connected to a first one of said arms; a second end connected to a second one of said arms; a medial section oriented to bear against the back of said user's head.

In some embodiments said distance is between 5.0 and 30 mm.

In some embodiments the free end of each of said support arms is located posteriorly from a coronal plane substantially bisecting said user's head when said device is worn.

In some embodiments said brace is under mechanically elastic strain wherein said strain amounts results in a decrease in a lateral gap between said free ends to be less than 5% of an unloaded gap.

In some embodiments said device further comprises: a first rigid guide bracket swivellingly mounted to a first one of said support arms.

In some embodiments said first flexible tensioning member comprises: a number of positioning straps.

In some embodiments said straps comprise a transverse strap and a coronal strap.

In some embodiments aid first end of said first tensioning member is spaced a lateral distance apart from said head.

In some embodiments said free ends are located at an angle of at least 185 degrees from one another as measured along the brace about a centroidal axis of a head to which the brace is secured.

In some embodiments there is provided a device which comprises: a headgear comprising: a rigid anterior oblong arcuate brace laterally spanning said forehead; said brace comprises: a pair of posteriorly projecting rigid support arms; a flexible posterior tensioning member comprising first and second opposite ends; and, wherein said opposite ends are connected to said arms.

In some embodiments each of said arms comprises a posterior free end; and wherein said tensioning member is under tension causing a laterally medial deflection said free ends.

In some embodiments a first one of said support arms comprises a free end spaced a lateral distance apart from said head.

In some embodiments said lateral distance is between 5.0 and 30 mm.

In some embodiments said headgear further comprises: a first oblong bracket comprising: a first end movably connected to said first support arm.

In some embodiments said first oblong bracket is hingedly connected to said first support arm.

In some embodiments a first one of said opposite ends of said tensioning member is wound upon a spool rotatively mounted to said bracket.

In some embodiments there is provided a method for increasing the comfort of headgear, said method comprises: selecting a headgear including a rigid arcuate brace having a pair of substantially rigid support arms straddling the user's head and extending laterally and posteriorly beyond a user's temples in a cantilevered manner to form a pair of free ends; attaching a tensioning member to said free ends; applying a tension load to said tensioning member; deflecting said free ends toward one another while avoiding contact of said arms with said head.

The original text of the original claims is incorporated herein by reference as describing features in some embodiments.

### BRIEF DESCRIPTION OF THE DRAWINGS

FIG. 1 is a prior art diagrammatic perspective view of a human head and its defined mutually orthogonal reference planes.

FIG. 2 is a prior art diagrammatic side illustration of headgear mounted upon a human head.

FIG. 3 is a prior art diagrammatic cross-sectional top view illustration of headgear mounted upon a human head.

FIG. 4 is a diagrammatic perspective view of a person wearing a compressive force accommodating headgear according to an alternate exemplary embodiment of the invention.

FIG. 5 is a prior art diagrammatic cross-sectional top view illustration of the compressive force accommodating headgear.

FIG. 6 is a diagrammatic cross-sectional top view illustration of the compressive force accommodating headgear undergoing strain due to a laterally compressive load.

FIG. 7 is a diagrammatic side illustration of the compressive force accommodating headgear mounted upon a human head providing greater resistance to pitching movement due to vertical loads.

FIG. 8 is a diagrammatic perspective view of a person wearing a compressive force accommodating headgear attached to a head and neck support device according to an alternate exemplary embodiment of the invention.

FIG. 9 is a diagrammatic cross-sectional top view of the compressive force accommodating headgear of FIG. 8.

FIG. 10 is a flow chart diagram of a method for using a compressive force accommodating headgear according to an exemplary embodiment of the invention.

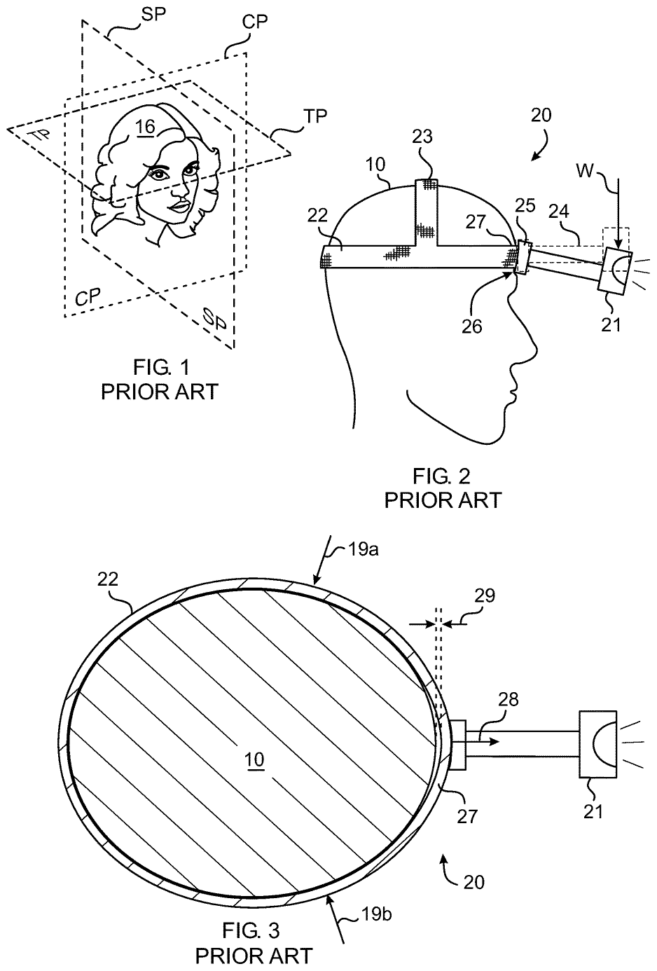

### DESCRIPTION OF THE EXEMPLARY EMBODIMENTS

In this specification, the references to top, bottom, upward, downward, upper, lower, vertical, horizontal, sideways, lateral, back, front, proximal, distal, etc. can be used to provide a clear frame of reference for the various structures with respect to other structures usually as oriented in the drawing being referred to. These references should not be treated as absolutes when the frame of reference is changed, such as when the device is inverted, shown on its side, or disassembled.

If used in this specification, the term “substantially” can be used with respect to manufacturing imprecision and inaccuracies that can lead to non-symmetricity and other inexactitudes in the shape, dimensioning, orientation, and positioning of various structures.

Further, use of “substantially” in connection with certain geometrical shapes and orientations, such as “parallel” and “perpendicular”, can be given as a guide to generally describe the function of various structures, and to allow for slight departures from exact mathematical geometrical shapes, such as cylinders, ellipses, disks and cones, and their orientations, while providing adequately similar function. Those skilled in the art will readily appreciate the degree to which a departure can be made from the mathematically exact geometrical references.

If used in this specification, the word “axial” is meant to refer to directions, movement, or forces acting substantially parallel with or along a respective axis, and not to refer to rotational nor radial nor angular directions, movement or forces, nor torsional forces.

In this specification the units “millimeter” or “millimeters” can be abbreviated “mm”, “centimeter” or “centimeters” can be abbreviated “cm”.

In this specification reference may be made to the use of numerous patches or layers of hook-and-vane fabric fastener such as VELCRO brand fastener available from Velcro USA Inc. of Manchester, New Hampshire in which a patch of hook-and-vane fabric fastener of a first type (either hook or vane) can releasably fasten to a patch of the opposite type. For example a patch of the hook type would releasably bond to a patch of the vane type or some other common, loosely woven fabrics. For clarity such fasteners are referred to in this specification as fabric fasteners, and a patch of fabric fastener will bond to a corresponding patch of fabric fastener.

Those skilled in the art will readily appreciate which type will best be used for any given patch and whether the type of matable patches can be swapped.

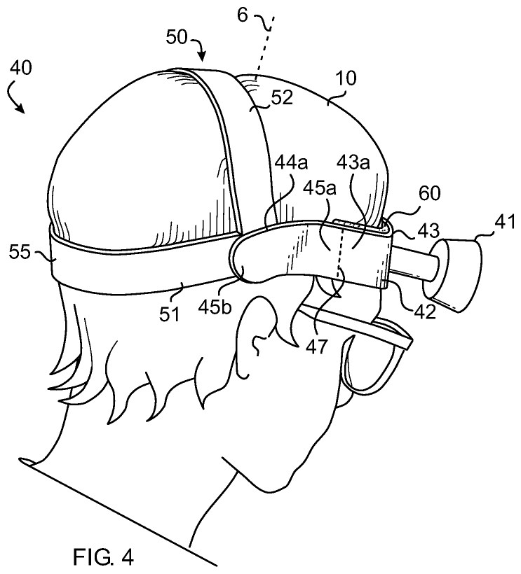

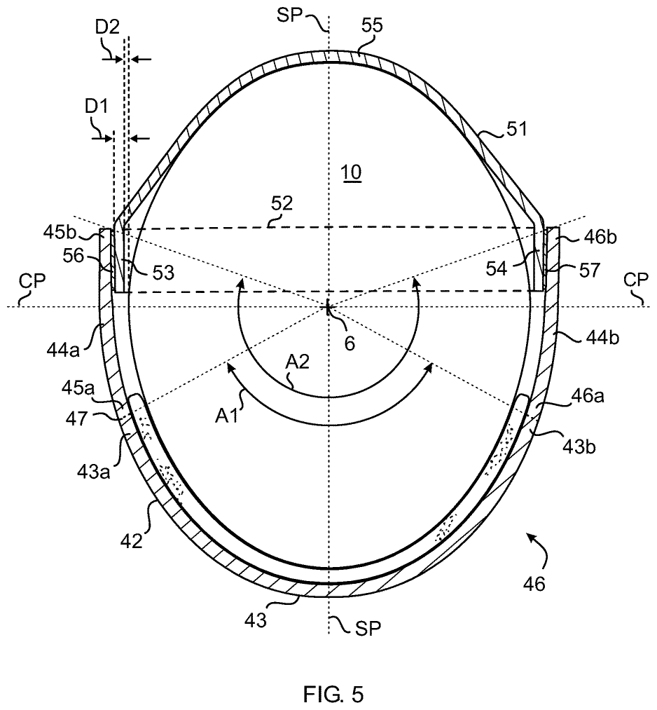

Referring now to FIGS. 4-5 there is shown a headgear 40 according to an exemplary embodiment of the invention for comfortably accommodating forces applied to it. Such forces can be applied by the influence of gravity upon an attachment 41 such as a flashlight, and/or a face shield for example.

The headgear 40 can include a rigid arcuate brace 42 extending substantially parallel to the transverse plane TP of the head and spanning the forehead of the wearer 10. The brace can include a rigid brow portion 43 having a bend radius of about 9 cm so that it can intimately secured against the forehead through a resilient pad 60 providing comfortable and conformance. A pair of support arm temple pieces 44a,44b can be cantileveredly supported by the brow piece. In other words, a first support arm 44a can have a fixed end 45a connected to the left lateral extent 43a of the brow portion, and an opposite free end 45b extending laterally and posteriorly in a cantilevered manner away from the head. Indeed, the free end can be located a lateral distance D1 apart from the head. For a typical brace having a bend radius of approximately 9 cm and an arc of approximately 225 degrees relative to the vertical centroidal axis of the head, a distance of between about 5.0 and 30 mm can be adequate.

Similarly, a second support arm 44b can have a fixed end 46a connected to the left lateral extent 43b of the brow portion, and an opposite free end 46b extending laterally and posteriorly in a cantilevered manner away from the head. In this way the brace can be symmetric about the sagittal plane SP of the head. It shall be understood that the entire brace, including the brow portion and both support arms can be made from a unitary piece of durable, rigid material such as carbon fiber composite or stainless steel for example. In this way the transition 47 between the medial brow portion and a support arm can be smooth without a clear demarcation between the brow portion extent and the fixed end of the support arm.

The headgear 40 can also include a flexible tensioning member 50 that can be formed by an oblong flexible strap 51 extending substantially parallel to the transverse plane TP and an oblong flexible coronal band 52 extending substantially parallel to the coronal plane CP. A first end 53 of the strap can be secured to the free end 45b of the first support arm 44a, while a second end 54 can be secured to the free end 46b of the second support arm 44b. A medial section 55 of the strap can be oriented to bear against the back of said user's head 10. The coronal band can extend across the top of the head substantially within the coronal plane CP and attach at its opposite ends to the free ends 45b,46b of the support arms. The length of the strap can be made adjustable using elastic material as shown or substantially inelastic material where various adjustable fasteners known in the art such as snaps, buckles, pinching grips, etc. can be used.

The flexible tensioning member 50 can be secured to the brace 42 in a number of ways. The two different material pieces can be attached using patches 56,57 of glue as shown. Alternately, they can be fastened using various commonly known fasteners such as screws, snaps, rivets, or other connectors. Alternately the pieces can be secured by cooperative couplings or other interlocking features formed into the geometries of the interfacing surfaces. Various hinged or swivelling connections can also be used. Depending on the materials used, they can be co-molded. For example, a polyethylene terephthalate (PET) flexible tensioning member can be injection molded upon a preformed carbon fiber brace. Various surface features such as vias through the brace can provide for a more rugged bond.

By attaching the tensioning member 50 to the fee ends 45b,46b of the support arms 44a,44b of the arcuate brace 42, the ends of the 53,54 of the strap 51 can be spaced a lateral distance D2 apart from the wearer's head 10. For a typical brace having a bend radius of approximately 9 cm and an arc of approximately 225 degrees relative to the vertical centroidal axis of the head, a distance of between about 2.0 and 15 mm can be adequate. This spacing can ensure that the load on the tensioning member be carried by the brace rather than the wearer's temples.

To further ensure that the load on the tensioning member 50 is carried by the brace 42, the brace can be dimensioned so that the free ends 45b,46b of the support arms are located posterior to the coronal plane CP intersecting the centroidal axis 6 of the head. By requiring that the angular separation of the free ends 45b,46b of the support arms be at an angle A2 of at least 185 degrees, and more preferably at least 190 degrees with respect to the central vertical axis 6 which passes through the centroid or volumetric center of the head, the laterally compressive load supplied by the tensioning member can be accommodated by the brace without undue deformation. By requiring that the angular separation of the fixed ends 45a,46a of the support arms be at an angle Al of at least 90 degrees, and more preferably at least 100 degrees, the support arms can be properly cantilevered laterally away from the head.

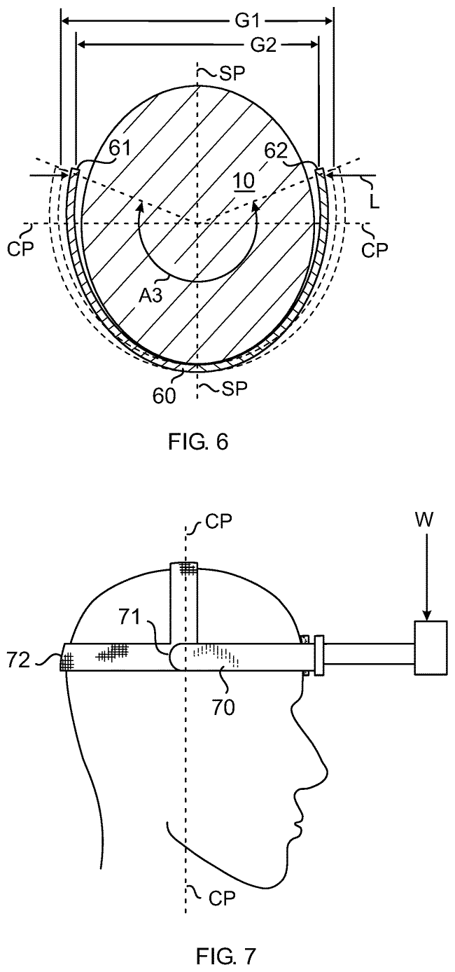

Referring now to FIG. 6, because of the limitations of materials and weight and size restrictions, the brace cannot be made completely rigid. Thus, a lateral compressive force will deflect the free ends of the support arms medially. However, a maximum amount of deflection that results in the support arms remaining spaced apart from the temples will be tolerated. Thus, for a brace 60 having a bend radius of approximately 9 cm and an arc A3 of approximately 225 degrees the lateral gap G1 between the free ends 61,62 will decrease by not more that 5% under a lateral compressing load L of approximately 2.25 Newtons (10 pounds force) applied at the free ends.

FIG. 7 shows that a brace 70 having a bend radius of approximately 9 cm and an arc of at least 185 degrees will allow the free ends 71 of the support arms to extend posteriorly beyond the coronal plane CP intersecting the centroidal axis of the head. The tension on the tensioning member 72 will tend to restrict any upward movement of the free ends due to the weight W of the attachment cantilevered anteriorly from the front of the brace. In this way the rigid arcuate brace of the headgear provides resistance to the pitch forces described in connection with FIGS. 2-3.

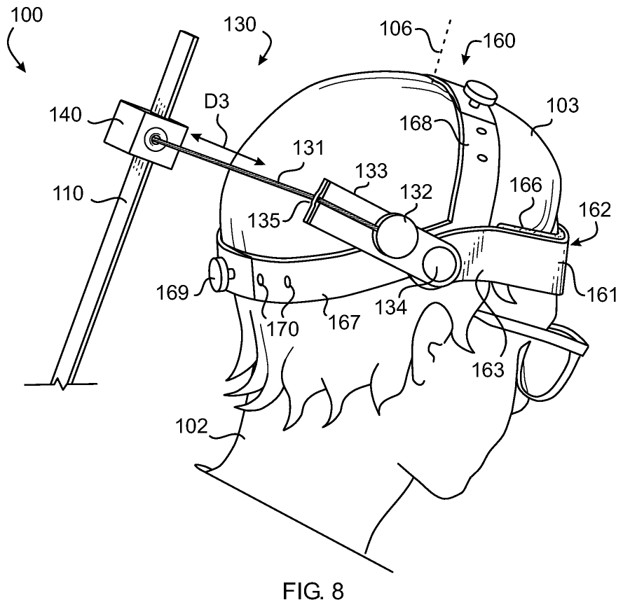

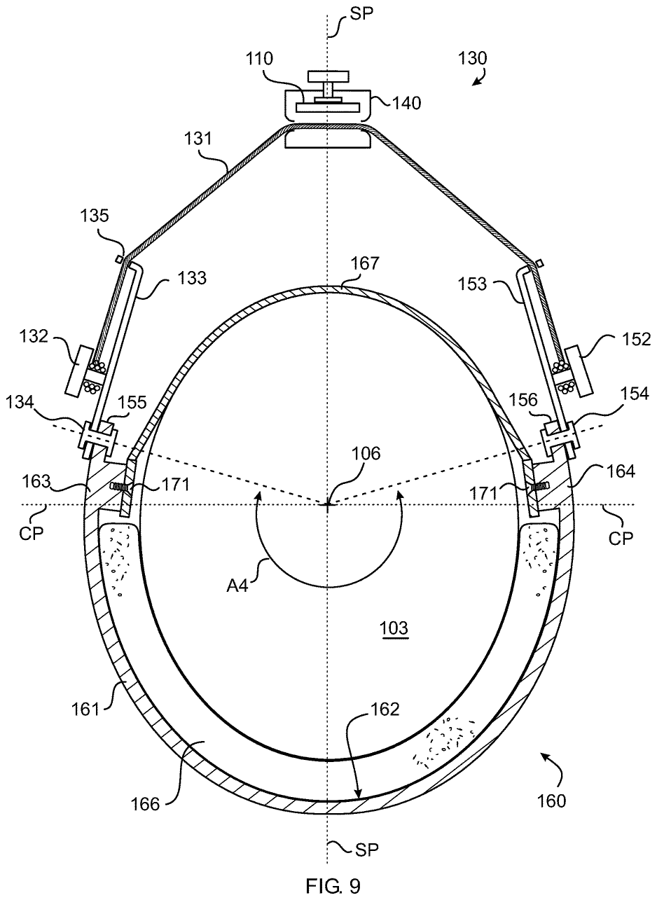

Referring now to FIGS. 8-9, there is shown an alternate embodiment of a headgear 160 for use in a device 100 that provides support for the head 103 and neck 102 of a wearer during repetitive and long duration activities such as occurs with assembly line workers. The headgear can be adapted to provide greater comfort for the wearer by including a padded rigid arcuate, lateral compression resistant brace 161 laterally spanning the head 103 substantially parallel to the transverse plane TP. The curvature of the brace is selected so that its concave brow portion 162 nests to the wearer's forehead while rigid lateral support arms 163,164 extend in a cantilevered manner laterally and posteriorly away from the wearer's temples and spaced away from the head. A pad 166 made of resilient material such as fabric covered foam rubber can form a more comfortable, intimately conforming surface between the brace and the forehead of the wearer. The arms provide a rigid structure to accommodate the potentially uncomfortable laterally compressive squeezing forces generated by the flexible adjustable transverse and coronal straps 167,168 and the support cable 131 described below. Each of the straps can be adjusted using a length adjustment mechanism 169 such as a spring loaded pin engaging discreet holes 170. The ends of the straps can be replaceably attached to the free ends of the support arms using screw fasteners 171.

A connector 130 can secure the headgear 160 to a beam 110 or other relatively fixed structure. The connector can include a flexible cable 131 in which both ends are secured to opposite sides of the headgear. A first end of the cable can secure to a spindle 132 rotatably mounted upon a guide bracket 133 attached to the free end 155 of a support arm 163 of the brace 161 at a swivel mount 134. The spindle can form a landing for the cable end on the headgear. The cable can be slidingly connected to the connector to allow the user to move their hear in a yaw motion with very little resistence.

The guide bracket 133 can include a cable guide 135 through which the cable slidingly passes and bears against. The opposite end of the cable can attach to a similar guide bracket 153 swivellingly mounted by a swivel 154 to the opposite support arm 164 of the brace 161 on the opposite side of the headgear with or without an adjustable spindle 152 forming another landing for the cable on the headgear. A middle portion of the cable can be slidingly secured to the housing 140 of the connector 130. The distance between the headgear and the relatively fixed structure such as the beam 110 can be adjusted by adjusting the amount of the cable wound upon the one or both of the spindles.

When providing head support, the cable 131 of the head and neck support device 100 is under tension, which in turn imparts a lateral compressive force on the headgear in addition to the lateral compressive force imparted by the headgear straps 167,168. Thus the combination of the straps and cable can form a tensioning member on the brace. The compressive forces are resisted by the rigid arcuate brace 161 in a manner which prevents the force from being borne by the temples of the wearer. This is accomplished by ensuring that the forces are applied to the brace near the free ends 155,156 of the support arms 163,164. Therefore, the location of the guide bracket swivel mounts 134,154 can be located posterior to the coronal plane CP intersecting the centroidal axis 106 of the head. By requiring that the angular separation of the swivel mounts be at an angle A4 of at least 185 degrees, and more preferably at least 190 degrees with respect to the centroidal axis 106, the laterally compressive load supplied by the cable and straps can be accommodated by the brace without undue deformation.

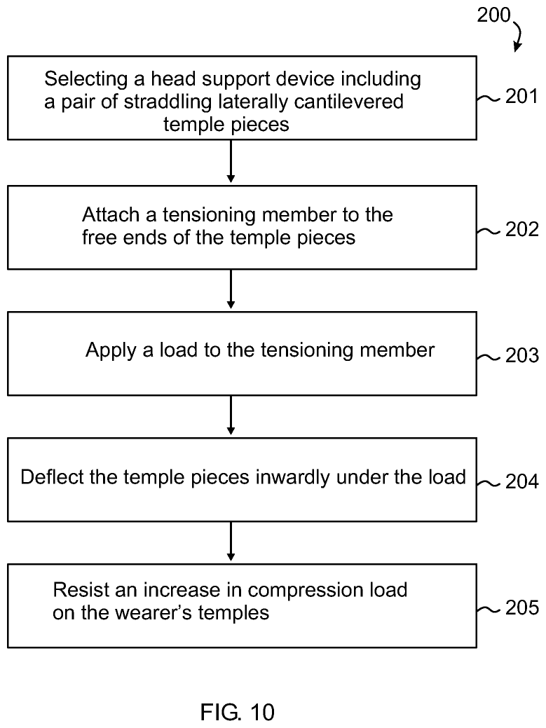

Referring now to FIG. 10 now will be described an exemplary embodiment of a method 200 for increasing the comfort of headgear which can under go laterally compressive loading.

The method can include selecting a headgear support device 201 including a rigid arcuate brace having a pair of substantially rigid support arms straddling the user's head and extending laterally and posteriorly beyond a user's temples in a cantilevered manner. A tensioning member can be attached 202 at either end to the free ends of the support arms. When a tension load is applied to the tensioning member 203 the arms will tend to deflect 204 toward the wearer's head. This deflection is resisted 205 by the rigidity of the brace.

The above-described embodiments of the brace can provide bending stiffness as a function of distance from the front end of the brace. The stiffness can be determined according to the geometry of the brace, its material characteristic such as fiber orientation for embodiments using fiber composite materials within the various zones of the brace, and the settings of the above-described adjustable features such as the tensioning cable.

In this way the device can provide greater comfort when the headgear is used in a head and neck support system for reducing loads imposed on the back, neck, spine and head during work and tasks related posture and body positioning.

In some embodiments the connector attaching the brace to the arms can have a quick coupling mechanism to allow easy engagement and disengagement to swap out a brace and pad having different mechanical or aesthetic properties.

In some embodiments the bending stiffness of the brace can vary along its length and is infinitely tunable for individual users. In some embodiments the brace can include one or more members having a tapered geometry where the edges can be bridged together. In some embodiments the brace can include one or more members made of a composite construct and designed to function as a lightweight counterbalance spring to the force of the cable.

While the preferred embodiments of the invention have been described, modifications can be made and other embodiments may be devised without departing from the spirit of the invention and the scope of the appended claims.

What is claimed is:

1. A device to be worn on a user's head, said device comprises:
a rigid arcuate brace configured to span a wearer's head;
wherein said brace comprises:
a brow portion secured anteriorly to a frontal part of said user's head;
a pair of arms cantileveredly connected to opposite lateral extents of said brow portion;
wherein each of said support arms comprises:
a free end laterally spaced a distance apart from said head;
a first flexible tensioning member comprising:
a first end connected to a first one of said arms;
a second end connected to a second one of said arms;
a medial section oriented to bear against the back of said user's head.

2. The device of claim 1, wherein said distance is between 5.0 and 30 mm.

3. The device of claim 1, wherein the free end of each of said support arms is located posteriorly from a coronal plane substantially bisecting said user's head when said device is worn.

4. The device of claim 1, wherein said brace is under mechanically elastic strain wherein said strain amounts results in a decrease in a lateral gap between said free ends to be less than 5% of an unloaded gap.

5. The device of claim 1, wherein said device further comprises:
a first rigid guide bracket swivellingly mounted to a first one of said support arms.

7. The device of claim 1, wherein said first flexible tensioning member comprises:
a number of positioning straps.

8. The device of claim 7, wherein said straps comprise a transverse strap and a coronal strap.

9. The device of claim 1, wherein said first end of said first tensioning member is spaced a lateral distance apart from said head.

10. The device of claim 9, wherein said free ends are located at an angle of at least 185 degrees from one another as measured along the brace about a centroidal axis of a head to which the brace is secured.

11. A device which comprises:
a headgear comprising:
a rigid anterior oblong arcuate brace laterally spanning said forehead;
said brace comprises:
a pair of posteriorly projecting rigid support arms;
a flexible posterior tensioning member comprising first and second opposite ends; and,
wherein said opposite ends are connected to said arms.

12. The device of claim 11, wherein each of said arms comprises a posterior free end; and
wherein said tensioning member is under tension causing a laterally medial deflection said free ends.

13. The device of claim 11, wherein a first one of said support arms comprises a free end spaced a lateral distance apart from said head.

14. The device of claim 13, wherein said lateral distance is between 5.0 and 30 mm.

15. The device of claim 11, wherein said headgear further comprises:
a first oblong bracket comprising:
a first end movably connected to said first support arm.

16. The device of claim 15, wherein said first oblong bracket is hingedly connected to said first support arm.

17. The device of claim 11, wherein a first one of said opposite ends of said tensioning member is wound upon a spool rotatively mounted to said bracket.

18. A method for increasing the comfort of headgear, said method comprises:
selecting a headgear including a rigid arcuate brace having a pair of substantially rigid support arms straddling the user's head and extending laterally and posteriorly beyond a user's temples in a cantilevered manner to form a pair of free ends;
attaching a tensioning member to said free ends;
applying a tension load to said tensioning member;
deflecting said free ends toward one another while avoiding contact of said arms with said head.
